(19) United States
(12) Patent Application Publication
(10) Pub. No.: US 2005/0215199 A1
(43) Pub. Date: Sep. 29, 2005

(54) Signal output apparatus equipped with a distortion canceller and a data transmission device using the apparatus

(76) Inventors: Akira Kabashima, Edgewater, NJ (US); Robert Rose, Lodi, NJ (US)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 10/810,275

(22) Filed: Mar. 26, 2004

(51) Int. Cl. H04B 1/00

(52) U.S. Cl. 455/63.1

(57) ABSTRACT

An amplifying output apparatus equipped with a distortion canceller may help reduce harmonic distortions superimposed on output signals even if distortions appear through an amplifier, thereby enabling outputs with smaller interference signals to be obtained. The techniques may enable an amplifying apparatus to operate with a low voltage so that such an amplifying apparatus can be provided at a low cost and also that it can be integrated on one chip with other integrated circuits.

### BACKGROUND OF THE INVENTION

1. Field of Invention

The present invention pertains to an amplifying output apparatus equipped with a distortion canceller, and in particular to a data transmission device employing such an apparatus.

2. Description of the Related Art

FIG. 1 is a conceptual diagram which depicts a cable television network. Broadcasting signals at, for instance, approximately 50 MHz to 800 MHz, which a broadcasting station (head end) 101 transmits, are supplied to each home 104 via a main-bus network 102 and a local net hub 103. A network connecting device 1 which is called a set top box is placed at each home 104. Network connecting device 1 decodes the broadcasting signals and supplies them as image signals to a TV reception device 105 at home 104. Frequencies are allotted for each channel in a frequency band of approximately 50 MHz to 800 MHz and broadcasting signals are transmitted in each channel.

In recent years, especially as digital broadcasting becomes popular, bidirectional broadcasting such as video on demand and online shopping is put into a practical use in which signals are not merely received but requests and a variety of user information signals generated at home are sent from home 104 to head end 101. A frequency band with a width of approximately 5 to 42 MHz is allotted to each home 104 for these user information signals so that the user information signals will not interfere with broadcasting signals, and set top box 1 of each home 104 transmits the information signals to head end 101 through such an allotted frequency band.

FIG. 2 is a block diagram illustrating the outline of home 104, and in particular that of set top box 1. Set top box 1 has a tuner 2, an input amplifier 3, a decoder 4, an encoder 5, an electric current amplifier 6 and output amplifier 7. Out of broadcasting signals from a cable network, the broadcasting signals in a channel having the frequencies which are selected by tuner 2 are selected and output to input amplifier 3. Input amplifier 3 amplifies the amplitude of the input signals by a predetermined amplification factor, and outputs them to decoder 4. Decoder 4 demodulates the digital broadcasting signals, converts them to digital or analog image signals which are suitable for a TV reception device 105, and output them to TV reception device 105. TV reception device 105 is a display apparatus which displays image signals. If necessary, a user who is watching images on TV reception device 105 inputs user signals containing an image request and user information by means of input devices 106 which are connected to set top box 1.

User signals are input to encoder 5 in set top box 1. Encoder 5 modulates user signals to digital data, converts them to signals at frequencies which are designated in advance in the frequency band of 5 to 42 MHz, and outputs them to output amplifier 7. Output amplifier 7 amplifies the amplitude of converted user signals by a predetermined amplification factor, and outputs them to the cable network.

User signals sometimes need to reach a head end 101 which is located several tens of kilometers away. However, if user signals are transmitted with a large output power, they may cause interference to other set top boxes. Therefore, precise controls are required on signal output power and output signal levels over a range from a large to small output power. Generally, however, there is an upper limit on an output voltage of an output amplifier after amplification. While absolute values of the voltages of signals input into an amplifier are smaller than a certain threshold value, the signals are amplified and output in proportion to the input signals. However, inputs which are larger than the threshold value can not be amplified, and waveform components which are called “distortions” appear. When distortions appear through an output amplifier 7 of the above mentioned network, for instance even if the user signals are created at 20 MHz, signals at frequencies which are integer multiples of that of the user signals, namely signals at 40 Mhz or 60 Mhz, are superimposed as interference signals. Such signals are called harmonic distortions. A synthesized waveform in which harmonic distortions are superimposed on user signals is recognized as signals at 40 MHz and 60 MHz. Therefore, not only do user signals not properly reach head end 101, but also they may interfere with user signals from another home 104 for which a frequency of 40 MHz is allotted as well as signals in a broadcasting signal band at 60 MHz.

FIG. 3 illustrates a typical output signal and a harmonic distortion through an output amplifier. FIG. 3 (a) depicts an ideal output waveform at 20 MHz. When a harmonic distortion at 60 MHz which is depicted in FIG. 3 (b) is added to this signal, a waveform appears as depicted in FIG. 3 (c). The waveform of FIG. 3 (c) is sometimes recognized as signals at 60 MHz depending on how peaks are detected. With this waveform, head end 101 will not correctly recognize the user signals. If signals at frequencies which are 2, 4 and 5 times higher than the original are further added to this waveform, a more complex waveform will be produced.

Therefore, in related arts, an output amplifier 7 could not be used in a medium voltage range B in FIG. 4 and could be used only in a low voltage range A.

### SUMMARY OF THE INVENTION

The present invention may help reduce harmonic distortions superimposed on output signals even if distortions appear through an amplifier, thereby enabling outputs with smaller interference signals to be obtained. Furthermore, using the invention may enable an amplifying apparatus to operate with a low voltage so that such an amplifying apparatus can be provided at a low cost and also that it can be integrated on one chip with other ICs.

Additional features and advantages will be apparent from the following detailed description, the accompanying drawings, and the claims.

### BRIEF DESCRIPTION OF THE DRAWINGS

FIG. 1: A conceptual diagram which illustrates a cable television network.

FIG. 2: A block diagram which illustrates a related art.

FIG. 3: A conceptual diagram which explains a harmonic distortion.

FIG. 4: Output properties of an output amplifier.

FIG. 5: A block diagram of the first embodiment.

FIG. 6: Output properties of a distortion canceller.

FIG. 7: Output properties of an output amplifier connected with a distortion canceller.

FIG. 8: A circuit diagram of an output amplifier connected with a distortion canceller.

FIG. 9: A block diagram of the second embodiment.

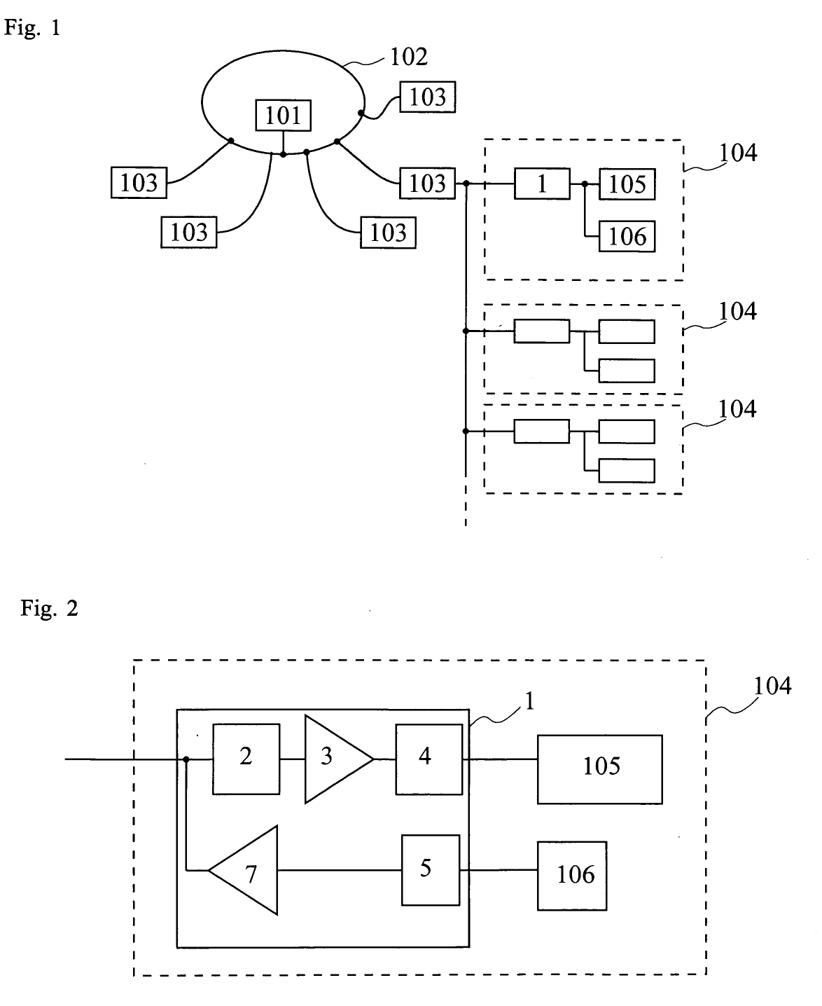

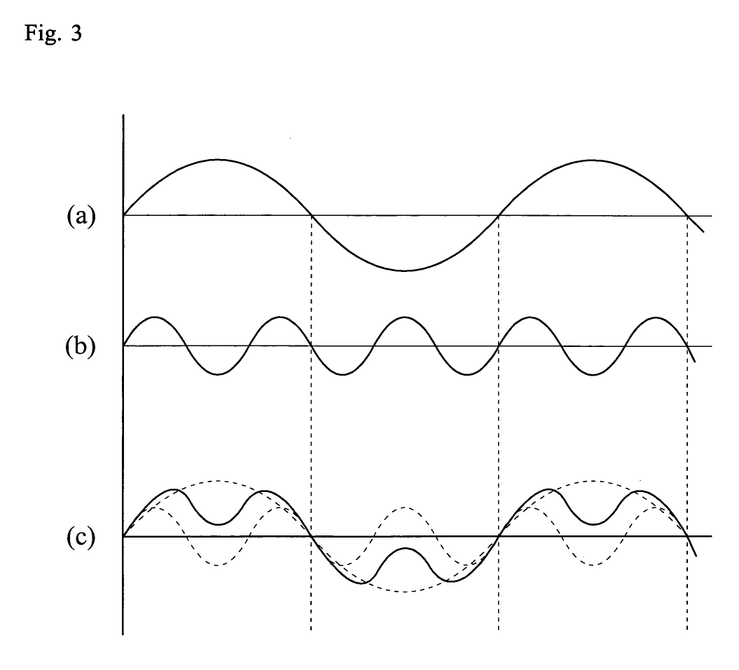

### DESCRIPTION OF THE PREFERRED EMBODIMENTS

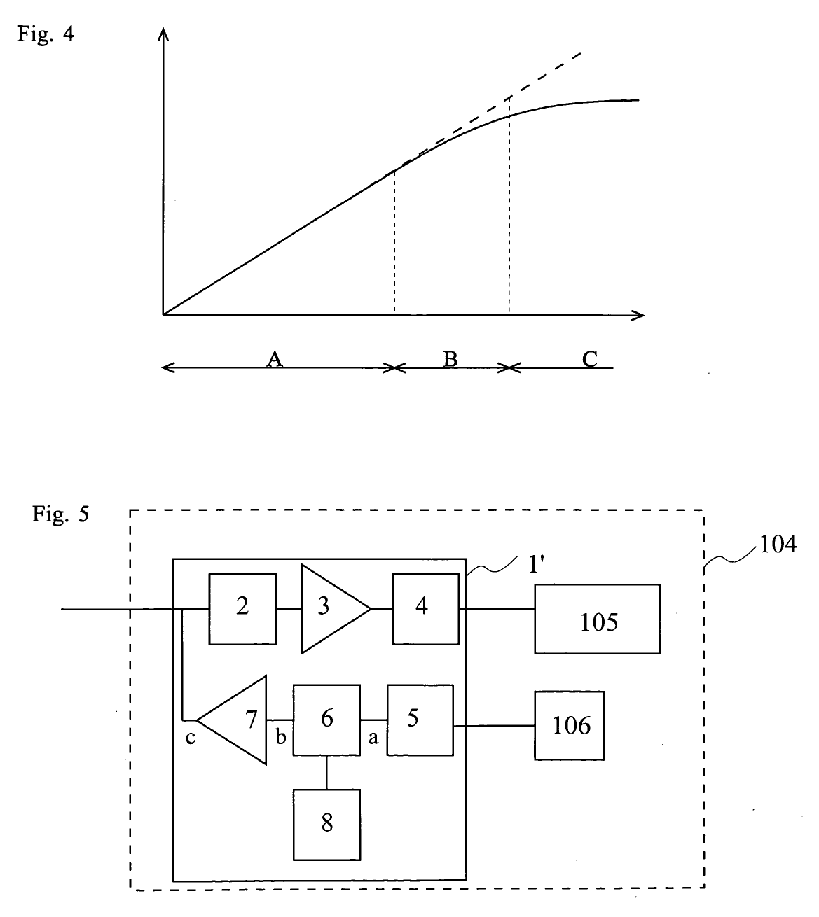

FIG. 4 illustrates a typical relationship between the input voltage and the output voltage of an output amplifier. The horizontal axis represents the input voltage to the amplifier and the vertical axis represents the output voltage of the amplifier. When the input voltage falls in a low voltage range A, there is enough reserve in the amplifier's amplifying capacity, and thus an output voltage which is proportional to the input voltage can be obtained. When the input voltage becomes larger through a medium voltage range B, the amplifier capacity reaches closer to its limit. Therefore, the rate of increase of the output voltage starts to become smaller. The output property curve deviates from the proportional output line which is represented with a dotted line, and makes a curve with a low increase rate which is represented with a solid line. Moreover, when the input voltage reaches a high voltage range C, the output voltage hardly becomes larger. Even if one tries to input signals at medium voltage range B and high voltage range C and to obtain output signals having amplitudes which are closer to the upper limit, output signals cannot be obtained with amplitudes proportional to those of the input signals. In the case where input signals are AC signals, harmonic distortions start to increase in medium voltage range B, and their influences become more significant in high voltage range C.

In order to reduce distortions from appearing, it is desired that an output amplifier have a capacity to produce sufficiently high outputs. An amplifier with a high power supply voltage can generate a high output voltage. Therefore, for example, providing a power supply voltage of an amplifier higher (for instance 12V) than that of a power supply voltage of other ICs (for instance 5V) is one solution. However, in order to integrate an amplifier using a high power supply voltage on a semiconductor circuit, it is required to form it through special processes. Hence, such a solution cannot meet the cost reduction requirement in a sufficient manner. Moreover, no matter what type of amplifier is constituted, it is difficult to eliminate distortions completely. Then the inventors of the present invention paid attention to the point that in medium voltage range B, while losing a proportional relationship with input signals, an amplifier output becomes larger for a larger input signal. Regarding this point, correcting input signals enables outputs to be obtained in which influences of harmonic distortions are reduced up to the area closer to the limit of the amplifier output.

FIG. 5 is a block diagram depicting the overview of a set top box 1′ according to the first embodiment of the present invention. Set top box 1′ has a tuner 2, an input amplifier 3, a decoder 4, an encoder 5, a pre-amplifier 6, an output amplifier 7 and a distortion generator 8. Out of broadcasting signals from a cable network, the broadcasting signals of a channel selected by tuner 2 are selected and output to input amplifier 3. Input amplifier 3 amplifies the amplitude of the input signals by a predetermined amplification factor, and outputs them to decoder 4. Decoder 4 demodulates digital broadcasting signals, converts them to digital or analog image signals that are suitable to a TV reception device 105, and outputs them to TV reception device 105. If necessary, a user who is watching TV reception device 105 inputs user signals containing an image request and user information by means of input devices 106 which are connected to set top box 1 either directly or via TV reception device 105. Examples of usage of input devices 106 include, but are not limited to, video on demand and internet access.

User signals are input to encoder 5 in set top box 1. Encoder 5 modulates the user signals to digital data, converts them to signals at frequencies which are selected from those of 5 to 42 MHz in order to transmit them to the cable network, and outputs them to pre-amplifier 6. Distortion generator 8 is a circuit which is connected to pre-amplifier 6 as an example of a distortion canceller. Distortion generator 8 has distortions with properties which are opposite of those of output amplifier 7, and superimposes distortion cancel signals, which will be explained below, on user signals and outputs them to output amplifier 7. Output amplifier 7 amplifies the amplitude of the user signals which are input by a predetermined amplification factor, and outputs them to the cable network.

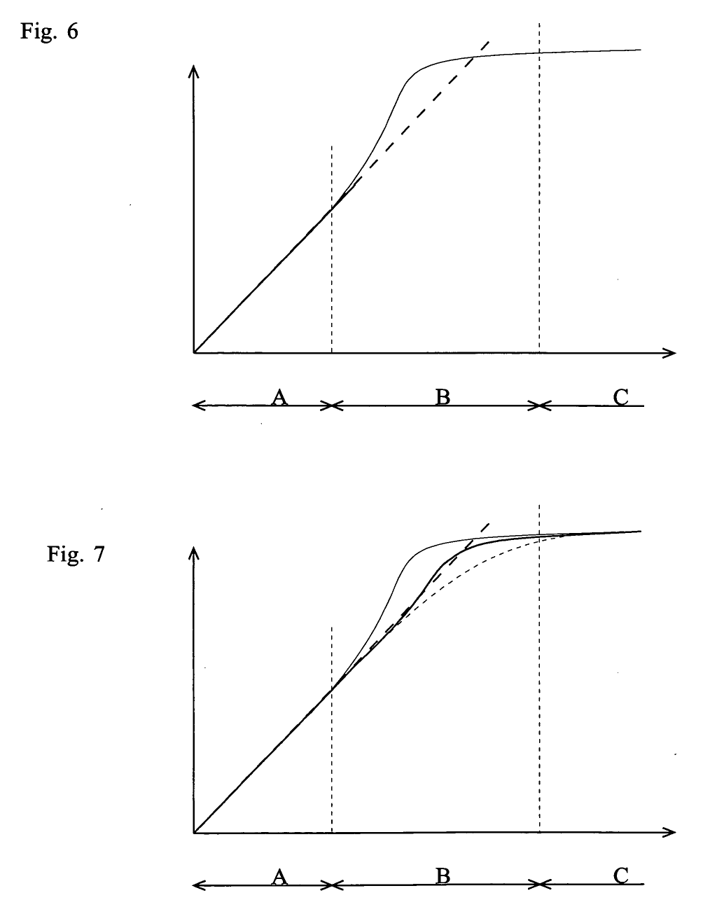

FIG. 6 illustrates a relationship between the input voltage and the output voltage of pre-amplifier 6 to which distortion generator 8 is connected. The rate of increase of the output voltage (the thin dotted line) of output amplifier 7 becomes smaller in medium voltage range B. In contrast, the output voltage of pre-amplifier 6 to which distortion generator 8 is connected has output properties in which the output voltage rises at a larger rate than the slope of the straight line depicting a proportional relationship in medium voltage range B, and in which then the output hardly increases in high voltage range C.

FIG. 7 illustrates a relationship between input signals to pre-amplifier 6 and output signals from output amplifier 7. The rate of increase of the output voltage of output amplifier 7 is smaller in medium voltage range B. Therefore, in order to enhance the increase of the output voltage in that range, distortion generator 8 adds distortion cancel signals to input signals and the signals are supplied to the output amplifier. Thereby, the final output signals can maintain an almost proportional relationship with the input signals (point a) up to a higher voltage range. As a result, distortions which had appeared in medium voltage range B hardly appear.

Properties of the amplification factor of distortion generator 8 are configured so that a substantially constant factor is maintained in low voltage range A and so that amplification in medium voltage range B is conducted with a larger amplification factor than that in low voltage range A. The amplification factor in low voltage range A may be a predetermined value, for example, in the present embodiment it is set to 1. In the case where this factor is 1, input signals are output without being amplified in low voltage range A, and only in medium voltage range B an amplification gain is given.

Distortion cancel signals which distortion generator 8 outputs are not outputs made at a specially set voltage. As described below, distortion generator 8 is also a type of amplifier, in which distortions appear according to the same principle as in output amplifier 7. However, its circuitry is devised so that the influences of distortions work in an opposite manner to those in output amplifier 7 at the output stage to reduce the deviation from proportional output line.

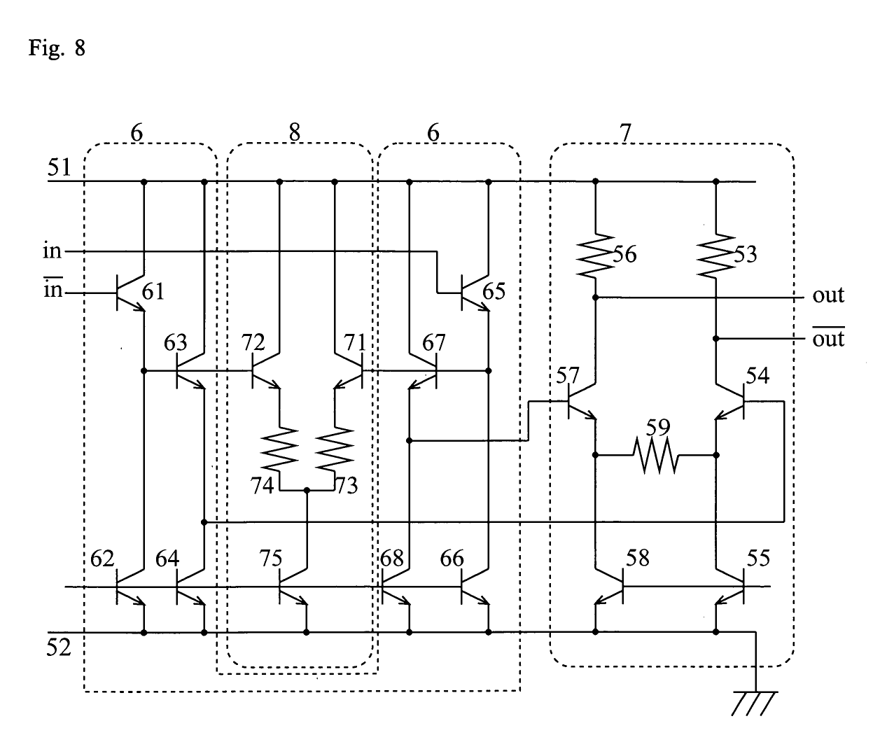

FIG. 8 is a circuit diagram which depicts an example of a specific circuit configuration of the present embodiment. The reference numeral 51 is a power supply line to which a constant voltage of 5V is applied and the reference numeral 52 is a ground line which comes in contact with the ground. Pre-amplifier 6 comprises four sets of transistors 61 to 68. Each set of two transistors are serially connected between power supply line 51 and ground line 52. Input signals and inverted input signals are input to the base of transistors 61 and 65, respectively, and they are output to output amplifier 7 as outputs of a Darlington emitter follower circuit.

In output amplifier 7, one resistor 53 and two transistors 54 and 55 are serially connected between power supply line 51 and ground line 52, and in the same fashion, a resistor 56 and transistors 57 and 58 are serially connected. A connection between transistors 54 and 55 and transistors 57 and 58 is provided through a resistor 59. Input signals of output amplifier 7 and inverted input signals are input to the base of transistors 54 and 57, respectively. Amplified output signals and inverted signals are output from between resistor 53 and transistor 54 and from between resistor 56 and transistor 57, respectively. The output gain of output amplifier 7 is determined by the resistance ratio of resistors 53, 56 and 59, and the distortion properties are determined by the resistance of resistor 59 and the collector current of transistors 55 and 58. Output amplifier 7 of the present embodiment consists of an amplifier circuit of a so-called differential type.

Distortion generator 8 includes a pair of transistors 71 and 72 which are connected to power supply line 51, a pair of resistors 73 and 74 which are connected to their emitters, and transistor 75 which is connected to both resistors 73 and 74. Because distortion generator 8 is a type of amplifier, distortions are generated therein as in output amplifier 7 when input signals to distortion generator 8 become larger and its amplitude approaches closer to the limit of its amplification capacity. The base of transistors 71 and 72 of distortion generator 8 are connected to the base of transistors 63 and 67 which are placed immediately before the output of the current amplifier. Therefore, when distortions are generated in distortion generator 8, the base current through transistors 71 and 72 does not increase, thereby suppressing reductions in the base voltages of transistors 63 and 67. Consequently, as shown in FIG. 6, the rate of the increasing signal at point b in FIG. 5 in medium voltage range B becomes larger.

A concrete method to match a distortion generation start voltage will be described. Distortions are generated because there is a limit for the dynamic range in which each transistor can control a voltage. Generated distortions differ according to the linearity properties which are unique to each transistor. Therefore, first of all, the size and shape of the transistors in output amplifier 7 and those of the transistors which constitute distortion generator 8 are matched so that their linearity will be substantially the same and similar distortions will be generated. Next, in the case of the circuit shown in FIG. 8, using resistor values R59, R73 and R74 of resistors 59, 73 and 74, as well as collector currents I55, I58 and I75 flowing through transistors 55, 58 and 75, the resistance value and current flowing through a transistor are determined so as to achieve a relationship,
R59×(I55+I58)=(R73+R74)×I75.
To show it more generally, regarding the circuit elements comprising output amplifier 7 and distortion generator 8, the products between the emitter currents of the transistors of the differential amplifier and the emitter resistances are made substantially equal. As a result, distortions begin to appear at the same threshold voltage in distortion generator 8 and output amplifier 7. In medium voltage range B, distortions of distortion generator 8 and those of output amplifier 7 cancel one another, and in the final output, distortions are suppressed. In the above mentioned equation, it is not necessary to satisfy the equation exactly. If the margin of error is within 30% or so, there should not be any problem in circuit operations. It is preferable to keep the margin of error within a range of 20%. Besides, when AC input signals are considered, harmonic distortions in output amplifier 7 are generated in an opposite manner to those appearing in distortion generator 8. Hence, harmonic distortions in output amplifier 7 and distortion generator 8 cancel each other, and the generation of harmonic distortions can be suppressed in the final output.

The present embodiment does not attempt to suppress the generation of distortions. In order to fundamentally stop the generation of distortions, it is necessary to considerably increase the current in the amplifier circuit, or to change the amplifier circuit drastically and create an amplifier with a completely different principle. In the present embodiment, the generation itself of distortions is tolerated. Distortions which work in an opposite manner are actively generated, and thereby only the influences of distortions are prevented within an applicable scope of existing technologies. In other words, in the present embodiment, it suffices as long as distortions are generated with the same voltage threshold and connections are made so that when distortions are generated, their influences cancel one another. As to the circuit configuration of output amplifier 7 and distortion generator 8, a variety of existing amplifier circuits can be employed. For instance, those skilled in the art can easily obtain, based on the present embodiment, output amplifier 7 and distortion generator 8 with identical circuits. In such a case, if transistor sizes, resistance values and so forth are matched completely, the distortion generation thresholds can be matched even more easily. Such a configuration makes circuit designing easier. In the present embodiment, as described above, high voltage output properties are regarded with more importance in output amplifier 7. As for distortion generator 8, because it deals with signals before amplification, suppressing its power consumption is considered to be more important and, thus, a circuit which works well at higher voltages with a lower power consumption is adopted.

Furthermore, rather than obtaining the value of a voltage threshold of distortion generation in a circuit on an experimental basis and adding a complementary circuit which is customized in response to the threshold value, the circuits in which distortions are generated with the same principle are connected so that the distortion influences inversely work, thereby making it possible to reduce the labor required for the circuit design while reducing variations in properties at the time of mass production. A customized circuit may allow for a smaller circuit size than that in the present embodiment. However, many types of circuits are suggested for an amplifier circuit and the threshold voltage for the distortion generation is determined by various factors such as a circuit configuration, transistor properties and resistance values. Therefore, it is difficult to exactly predict the distortion generation threshold at the stage in which a circuit is designed. Hence, in order to design a distortion canceling circuit which is customized for a certain amplifier, an output amplifier 7 should be prepared first and its distortion generation threshold can be obtained on an experimental basis. Then a circuit which is suitable for its properties can be designed. In the present embodiment, a circuit in which distortions are generated according to the same principle as in output amplifier 7 is connected so that it works in an inverse manner. Therefore, such an experiment may not be necessary and designing a circuit may be easier.

Moreover, in the process of manufacturing semiconductors, it is difficult to exactly match transistor properties in entire production lots while conducting production. In a customized distortion canceling circuit, if the distortion generation threshold of amplifiers varies due to variations in production, there is a concern that the threshold and the operation points of the canceling circuit do not match and the canceling circuit may prove to be less effective. On the other hand, in the present embodiment, a distortion generator 8 in which the principle of distortion generation itself is identical to that in an output amplifier is provided. Therefore, even if there are variations in production which result in variations of the distortion generation threshold, variations in an output amplifier 7 and a distortion generator 8 would be substantially equal and thus good results may be obtained regardless of variations. Furthermore, in FIG. 4 and FIG. 6, curvatures with which output property curves deviate from the proportional straight line become almost equal in medium voltage range B. In other words, a self adjustment can be realized in that when distortions in output amplifier 7 become larger, distortions in distortion generator 8 also become larger. Consequently, the circuits exhibits sufficient effects of canceling one another in medium voltage range B, and in the final output properties shown in FIG. 7, a voltage range up to medium voltage range B can be utilized.

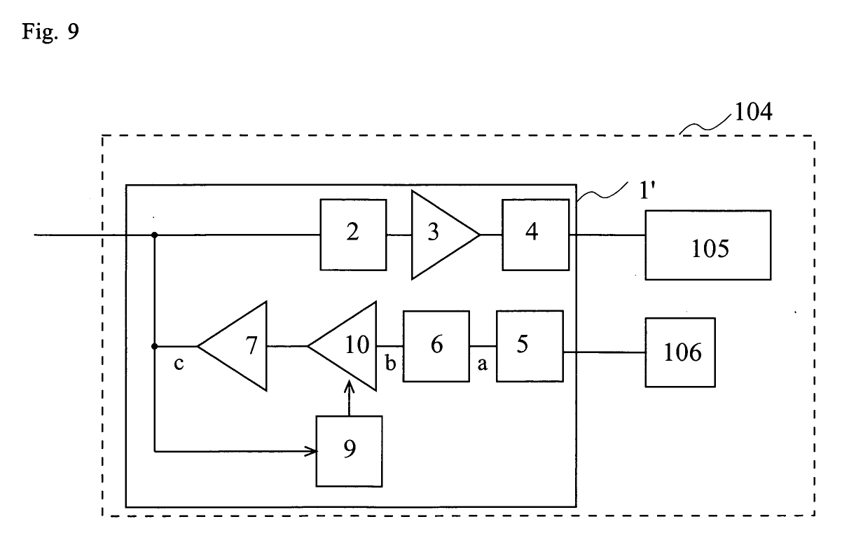

FIG. 9 illustrates the second embodiment of the present invention. In the second embodiment, as a distortion canceller, a pre-amplifier 10 is serially connected to the front end of an output amplifier 7. The pre-amplifier is constituted so that it exhibits the output properties shown in FIG. 6. Its distortions have effects inverse to those of output amplifier 7, and it has output properties such as to reduce the influences of the distortions appearing in output amplifier 7. The principle for the reduction of the influences of distortions is the same as that in the first embodiment.

Further, a distortion detector 9 which receives outputs from output amplifier 7 may be connected. Distortion detector 10 detects outputs which are at frequencies which are integer multiples of a frequency by an encoder 5, and output them to pre-amplifier 10. In this case, although pre-amplifier 10 normally has a gain of 1, it is constituted so that its gain will be increased according to the outputs from pre-amplifier 10. When the constitution is done in this manner, pre-amplifier 10 does not have to be constituted to have the output properties shown in FIG. 6.

The present invention can be employed in various applications other than a set top box for a cable network. For example, the present invention can be employed in data transmission device for a telephone line, multi-channel communication network or any other data networks. One can make the maximum use of the effects of the present invention in situations where one desires to obtain an output at a voltage several volts higher and to suppress the influences of distortions in a range close to the rated power limit, without changing the power voltage of an output amplifier. In the case of the present embodiment, the necessary circuitry can be formed on the same chip with a tuner 2 and an encoder 5, thereby realizing a 1-chip system while maintaining a 5V power supply and maintaining the upper limit of the output signals at 5V.

Other implementations are within the scope of the claims.

1. A signal output apparatus comprising
an output amplifier to amplify input signals to output signals, and
a distortion canceller coupled to an input of the output amplifier,
wherein harmonic distortions appear in said output amplifier and said distortion canceller, and
said harmonic distortions from said output amplifier and those from said distortion canceller are created in an opposing manner such that cancellation occurs.

2. The signal output apparatus according to claim 1 wherein said output amplifier and said distortion canceller have substantially the same threshold voltage at which distortions appear.

3. The signal output apparatus according to claim 1 wherein said distortion canceller includes an amplifier circuit.

4. The signal output apparatus according to claim 3 wherein said distortion canceller has almost no influences on outputs of the signal output apparatus in a low voltage range and increases an amplitude of said distortion canceller in a medium voltage range.

5. The signal output apparatus according to claim 4 wherein due to the influences of said distortion canceller, a relationship between input signals and final outputs of said signal output apparatus becomes closer to a proportional relationship than that without any influence of said distortion canceller.

6. The signal output apparatus according to claim 3 wherein a gain of said distortion canceller is approximately 1 in the low voltage range.

7. The signal output apparatus according to claim 3 wherein said output amplifier and said distortion canceller employ a different type of amplifier circuit from one another.

8. The signal output apparatus according to claim 3 wherein said output amplifier employs a type of amplifier circuit in which high voltage output properties are superior to those of said distortion canceller.

9. The signal output apparatus according to claim 3 wherein said distortion canceller has a smaller power consumption than that of said output amplifier.

10. The signal output apparatus according to claim 3 wherein said output amplifier includes a differential amplifier.

11. The signal output apparatus according to claim 3,
wherein said output amplifier has a first transistor which is coupled between a power supply line and a ground line, a second transistor which is coupled in parallel to said first transistor between the power supply line and the ground line, and a first resistor which is coupled between said first and second transistors and the ground line, and
wherein said distortion canceller has a third transistor whose collector is coupled to the power supply line and whose emitter is coupled to a second resistor, and a fourth transistor whose collector is coupled to the power supply line and whose emitter is coupled to a third resistor, whereas an end of the second and third resistor which are opposite to the second and third transistors are coupled to one another, and the point of coupling is coupled to the ground line.

12. The signal output apparatus according to claim 11 wherein each of the first to fourth transistors comprises a plurality of transistors, wherein the number of transistors comprising the first and second transistors is larger than the number of transistors comprising the third and fourth transistors.

13. The signal output apparatus according to claim 12 wherein
a fifth transistor is coupled between the first transistor and the ground line,
a sixth transistor is coupled between the second transistor and the ground line, and
said point of coupling between second and third transistors is coupled to the ground line via a seventh transistor.

14. The signal output apparatus according to claim 13 wherein each of the fifth to seventh transistors comprises a plurality of transistors, wherein the number of transistors comprising the fifth and sixth transistors is larger than the number of transistors comprising the seventh transistor.

15. The signal output apparatus according to claim 1 wherein a current amplifier to amplify a current without amplifying a voltage is coupled to an input end of said output amplifier, and said distortion canceller is coupled to said current amplifier.

16. The signal output apparatus according to claim 3 wherein among circuit elements which comprise said output amplifier and said distortion canceller, the product of a collector current through a transistor connected to the ground line and a resistance value of a resistor connected to the ground line through the transistor is substantially equal in said output amplifier and said distortion canceller.

17. A data transmission device including said signal output apparatus according to claim 1.

18. A signal output apparatus which multiplies the amplitude of an input signal by a predetermined factor and outputs it as an output signal and
which has an output amplifier and a pre-amplifier,
wherein
said output amplifier has output properties
in which its output has a relationship proportional to an input when the input signal is in a low voltage range,
in which its output deviates from the relationship proportional to an input when the input signal is in a medium voltage range, and
in which its output voltage hardly increases or does not increase at all when the input signal is in a high voltage range, and
wherein
said pre-amplifier has output properties
in which its output has a relationship proportional to an input when an input signal is in said low voltage range, and
in which its output deviates from the relationship proportional to an input into an opposite manner to the deviation of said output amplifier when the input signal is in said medium voltage range.

19. The signal output apparatus according to claim 18 wherein said output amplifier and said pre-amplifier have substantially the same threshold voltage at which deviations appear.

20. The signal output apparatus according to claim 18 wherein said pre-amplifier includes an amplifier circuit.

21. The signal output apparatus according to claim 20 wherein said pre-amplifier has almost no influences on outputs of the signal output apparatus in a low voltage range and increases an amplitude of said distortion canceller in a medium voltage range.

22. The signal output apparatus according to claim 20 wherein due to the influences of said pre-amplifier, a relationship between input signals and final outputs of said signal output apparatus becomes closer to a proportional relationship than that without any influence of said pre-amplifier.

23. The signal output apparatus according to claim 20 wherein a gain of said pre-amplifier is approximately 1 in the low voltage range.

24. The signal output apparatus according to claim 20 wherein said output amplifier and said pre-amplifier employ a different type of amplifier circuit from one another.

25. The signal output apparatus according to claim 20 wherein said output amplifier employs a type of amplifier circuit in which high voltage output properties are superior to those of said pre-amplifier.

26. The signal output apparatus according to claim 20 wherein said pre-amplifier has a smaller power consumption than that of said output amplifier.

27. The signal output apparatus according to claim 20 wherein said output amplifier includes a differential amplifier.

28. A data transmission device including said signal output apparatus according to claim 18.

29. A signal output apparatus which multiplies the amplitude of an input signal by a predetermined factor and outputs it as an output signal and
which has an output amplifier and a pre-amplifier,
wherein said output amplifier has output properties in which its output has a relationship proportional to an input when an input signal is in a low voltage range,
in which its output becomes lower than the relationship proportional to the input represents when the input signal is in a medium voltage range, and
in which its output voltage hardly increases or does not increase at all when the input signal is in a high voltage range,
said pre-amplifier supplies said input signal without being amplified to said output amplifier when the input signal is in said low voltage range, and amplifies by a predetermined gain and supplies to said output amplifier when the input signal is in said medium voltage range.

30. The signal output apparatus according to claim 29 wherein said output amplifier and said pre-amplifier have substantially the same threshold voltage at which deviations appear.

31. The signal output apparatus according to claim 29 wherein said pre-amplifier includes an amplifier circuit.

32. The signal output apparatus according to claim 31 wherein said pre-amplifier has almost no influences on outputs of the signal output apparatus in a low voltage range and increases an amplitude of said distortion canceller in a medium voltage range.

33. The signal output apparatus according to claim 31 wherein due to the influences of said pre-amplifier, a relationship between input signals and final outputs of said signal output apparatus becomes closer to a proportional relationship than that without any influence of said pre-amplifier.

34. The signal output apparatus according to claim 31 wherein a gain of said pre-amplifier is approximately 1 in the low voltage range.

35. The signal output apparatus according to claim 31 wherein said output amplifier and said pre-amplifier employ a different type of amplifier circuit from one another.

36. The signal output apparatus according to claim 31 wherein said output amplifier employs a type of amplifier circuit in which high voltage output properties are superior to those of said pre-amplifier.

37. The signal output apparatus according to claim 31 wherein said pre-amplifier has a smaller power consumption than that of said output amplifier.

38. The signal output apparatus according to claim 31 wherein said output amplifier includes a differential amplifier.

39. A data transmission device including said signal output apparatus according to claim 29.
